(19) United States
(12) Patent Application Publication
(10) Pub. No.: US 2005/0254361 A1
(43) Pub. Date: Nov. 17, 2005

(54) Device and method for controlling recording speed of a recording and reproducing apparatus

(75) Inventors: Chin-Yin Tsai, Hsin-Tien (TW); Yi-Lin Lai, Hsin-Tien (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: VIA TECHNOLOGIES, INC., Hsin-Tien (TW)

(21) Appl. No.: 11/104,660

(22) Filed: Apr. 13, 2005

Related U.S. Application Data
(60) Provisional application No. 60/561,536, filed on Apr. 13, 2004.

(51) Int. Cl. G11B 7/00

(52) U.S. Cl. 369/44.25; 369/44.27; 369/44.34; 369/124.01

(57) ABSTRACT

The recording speed controlling method for a recording and reproducing apparatus of the present invention including: compensating the focus error (FE) signal as a focus servo output (FOO) signal; low-pass filtering the FOO signal with second order into a FOO_LPF signal; detecting if a peak-to-peak voltae (Vpp) of the FOO_LPF signal reaches a limited voltage; and if yes, reducing the recording speed, else, keeping the recording speed. The tracking error (TE) signal could be an alternative of the FE signal, or both the two signals are taken as the judgment of controlling recording speed.

### CROSS REFERENCE TO RELATED APPLICATIONS The present application claims priority to U.S. Patent Application Ser. No. 60/561,536 filed Apr. 13, 2004, hereby incorporated by reference.

### BACKGROUND OF THE INVENTION

1. Field of the Invention

The present invention is related to a device and a method of recording and reproducing apparatus, more particularly to a device and a method for controlling recording speed of a recording and reproducing apparatus.

2. Description of the Related Art

In recent years, disk-shaped recording media such as CD-R, CD-RW, DVD-RAM, and DVD−RW are, widely used due to its high capacity storage and more and more low price, so recording and reproducing apparatus are public to help user writing data into a disk-shaped recording medium.

A blank disk having some recording information in ATIP (Absolution Time In Pre-groove) signal. Before recording the disk, the recording and reproducing apparatus read the ATIP information to derive the maximum supporting recording speed of the blank disk. But during the recording, the recording speed would change due to some reasons such as data buffer insufficient or mechanism problems. Therefore, it is important to control the recording speed to ensure correct recording data.

In common, the recording and reproducing apparatus uses both tracking error

### SUMMARY OF THE INVENTION

The recording speed controlling method and device for a recording and reproducing apparatus of the present invention is provided.

In the embodiment of the present invention, the recording speed controlling method including: compensating a first reference signal as a second reference signal; low-pass filtering the second reference signal as a third reference signal; detecting a peak-to-peak voltage (Vpp) of the third reference signal; wherein reducing the recording speed when the peak-to-peak voltage reaches a threshold voltage.

In the embodiment of the present invention, second order low-passing filtering the second reference signal.

In the embodiment of the present invention, the first reference signal is a focus error signal and the second reference signal is a focus servo output signal.

In the embodiment of the present invention, the first reference signal is a tracking error signal and the second reference signal is a tracking servo output signal.

In one of the embodiment of the present invention, the recording speed controlling method including: compensating a TE signal as a TRO signal and a FE signal as a FOO signal; low-pass filtering the TRO signal with 2^{nd} order as a TRO_LPF signal and the FOO signal with 2^{nd} order as a FOO_LPF signal; and detecting peak-to-peak voltages (Vpp) of the TRO_LPF signal and the FOO_LPF signal; wherein reducing the recording speed when one of the peak-to-peak voltages reaches a threshold voltage.

In one of the embodiment of the present invention, the recording speed controlling device for a recording and reproducing apparatus including: a compensator, compensating a first reference signal as a second reference signal; a low pass filter, coupled to the compensator, low-pass filtering the second reference signal as a third reference signal; a peak to peak voltage detector, coupled to the low pass filter, detecting a peak-to-peak voltage of the third reference signal; and a driver, coupled to the compensator and the peak to peak voltage detector, controlling the recording or reading speed of an optical pickup unit; wherein when a peak-to-peak voltage of the third reference signal reaches a threshold voltage, the drivers controls the optical pickup unit to reduce recording speed.

In the embodiment of the present invention, the low pass filter is a second-order low pass filter.

In the embodiment of the present invention, the first reference signal is a focus error signal and the second reference signal is a focus servo output signal.

In the embodiment of the present invention, the first reference signal is a tracking error signal and the second reference signal is a tracking servo output signal.

In another one of the embodiment of the present invention, the recording speed controlling device for a recording and reproducing apparatus including: a first compensator, compensating a tracking error (TE) signal as a tracking servo output (TRO) signal; a second compensator, compensating a focus error (FE) signal as a focus servo output (FOO) signal; a first low pass filter, coupled to the first compensator, low-pass filtering the TRO signal as a TRO_LPF signal; a second low pass filter, coupled to the second compensator, low-pass filtering the FOO signal as a FOO_LPF signal; a peak to peak voltage detector, coupled to the first low pass filter and the second low pass filter, detecting peak-to-peak voltages of the TRO_LPF signal and the FOO_LPF signal; and a driver, coupled to the first compensator, the second compensator and the peak to peak voltage detector, controlling an optical pickup unit to record and read a disk; wherein when one of the peak-to-peak voltages of the TRO_LPF signal and the FOO_LPF signal reaches a threshold voltage, the drivers controls the optical pickup unit to reduce recording speed.

In the embodiment of the present invention, the low pass filter is a second-order low pass filter.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows the recording speed controlling method for a recording and reproducing apparatus of the present invention;

FIG. 2 shows the recording speed controlling device for a recording and reproducing apparatus of the present invention by using the FE signal as a judgment;

FIG. 3 shows the recording speed controlling device for a recording and reproducing apparatus of the present invention by using both the FE and the TE signals as the judgment.

### DETAILED DESCRIPTION

The present invention provides a recording speed control method and a recording speed control device for a recording and reproducing apparatus. As a result, when in high speed recording, the recording speed could be preciously control to ensure correct data recording. In the present invention, the focus error signal or the tracking error signal or both the two signals are taken as the judgment of controlling recording speed.

A preferred embodiment is given as following to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore the present invention is not intended to be limited to the particular embodiments shown and described herein, but is to be accorded the widest herein disclosed.

The recording speed controlling method for a recording and reproducing apparatus of the present including: compensating a focus error (FE) signal as a focus servo output (FOO) signal; low-pass filtering the FOO signal with 2^{nd} order as a FOO_LPF signal; detecting if a peak-to-peak voltage (Vpp) of the FOO_LPF signal reaches a limited voltage; and if yes, reducing the recording speed, else, keeping the recording speed.

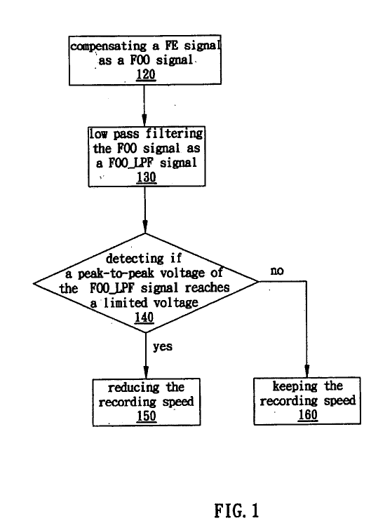

FIG. 1 shows the flowchart of the present invention when recording a disk.
Step 120: compensating a FE signal as a FOO signal;
Step 130: low pass filtering the FOO signal as a FOO_LPF signal;
Step 140: detecting if a peak-to-peak voltage (Vpp) of the FOO_LPF signal reaches a limited voltage;
if yes, goes to step 150, else goes to step 160,
Step 150: reducing the recording speed; and
Step 160: keeping the recording speed.

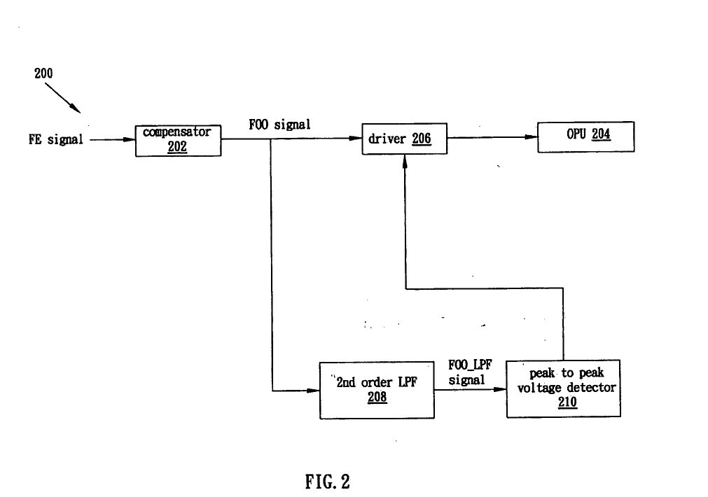

FIG. 2 shows the recording speed controlling device 200 for a recording and reproducing apparatus of the present invention, the device includes: a compensator 202, compensating the FE signal as a FOO signal; an optical pickup head unit (OPU) 204, recording or reading a disk; a driver 206, coupled between the compensator 202 and the OPU 204, controlling the recording or reading speed of the OPU 204; a 2^{nd} order low pass filter 208, coupled to the compensator 202, low-pass filtering the FOO signal as a FOO_LPF signal, as a reference controlling signal of recording speed; a peak to peak voltage detector 210, coupled between the 2_{nd} order low pass filter 208 and the driver 206, detecting a peak-to-peak voltage (Vpp) of the FOO_LPF signal, if the Vpp of the FOO_LPF signal reaches a limited voltage, the driver 206 reduces the recording speed of the OPU 204. The peak to peak voltage detector 210 can be implemented by a digital signal processor (DSP) or a micro processor.

As the forgoing mentioned, the FE signal is taken as the judgment for determining whether the recording speed needs to be reduced or not. However, the tracking error (TE) signal can be alternative of the focus error signal. The method and the device are as similar as the description above. Reference to FIG. 2, which shows the recording speed controlling device 200 for a recording and reproducing apparatus of the present invention, this time FE signal is replaced by TE signal. The device includes: a compensator 202, compensating the TE signal into a tracking servo output (TRO) signal; an OPU 204, recording or reading a disk; a driver 206, coupled between the compensator 202 and the OPU 204, controlling the recording or reading speed of the OPU 204; a 2^{nd} order low pass filter 208, coupled to the compensator 202, low-pass filtering the TRO signal as a TRO_LPF signal, as a reference controlling signal of recording speed; a peak to peak voltage detector 210, coupled between the 2^{nd} order low pass filter 208 and the driver 206, detecting a peak-to-peak voltage (Vpp) of the TRO_LPF signal, if the Vpp of the TRO_LPF signal reaches a limited voltage, the driver 206 reduces the recording speed of the OPU 204.

Also the recording speed controlling method for a recording and reproducing apparatus of the present including: compensating a TE signal as a TRO signal; then low-pass filtering the TRO signal with 2^{nd} order as a TRO_LPF signal; detecting if a peak-to-peak voltage (Vpp) of the TRO_LPF signal reaches a limited voltage; and if yes, reducing the recording speed, else, keeping the recording speed.

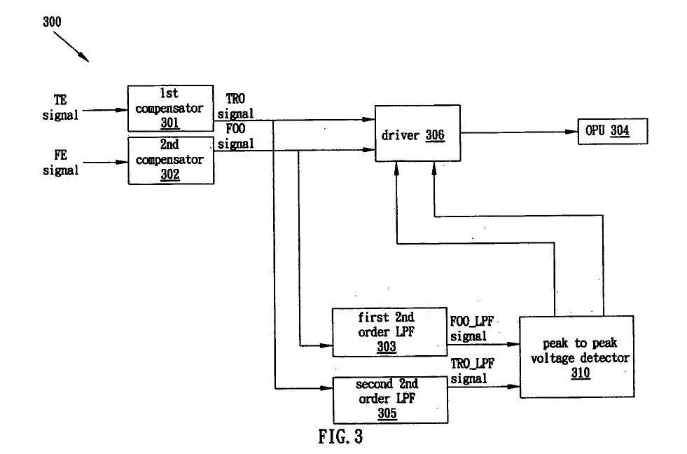

Furthermore, the invention can also use both the FE signal and the TE signal to determine the recording speed of the recording and reproducing apparatus. Please see FIG. 3, the recording speed controlling device 300 for a recording and reproducing apparatus of the present invention is implemented by using both the FE and the TE signals as the judgment. The device 300 includes: a first compensator 301, compensating a TE signal as a TRO signal; a second compensator 302, compensating a FE signal as a FOO signal; an OPU 304, recording or reading a disk; a driver 306, coupled between the first compensator 301, the second compensator 302 and the OPU 304, controlling the recording or reading speed of the OPU 304; a first 2^{nd} order low pass filter 303, coupled to the second compensator 302, low-pass filtering the FOO signal as a FOO_LPF signal, as a reference controlling signal of recording speed; a second 2^{nd} order low pass filter 305, coupled to the first compensator 301, low-pass filtering the TRO signal as a TRO_LPF signal, as a reference controlling signal of recording speed; a peak to peak voltage detector 310, coupled between the first 2^{nd} order low pass filter 303, the second 2^{nd} order low pass filter 305 and the driver 306, detecting peak-to-peak voltages (Vpp) of the FOO_LPF signal and the TRO_LPF signal , if one of the Vpp of the FOO_LPF signal and TRO_LPF signal reaches a limited voltage, the driver 306 reduces the recording speed of the OPU 304. The peak to peak voltage detector 310 also can be implemented by a digital signal processor (DSP) or a micro processor.

Also the recording speed controlling method for a recording and reproducing apparatus of the present including: compensating a TE signal as a TRO signal; compensating a FE signal as a FOO signal; low-pass filtering the TRO signal with 2^{nd} order as a TRO_LPF signal; low-pass filtering the FOO signal with 2^{nd} order as a FOO_LPF signal; detecting if one of peak-to-peak voltages (Vpp) of the TRO_LPF signal and the FOO_LPF signal reaches a limited voltage; and if yes, reducing the recording speed, else, keeping the recording speed.

As the descriptions above, the present invention provides a recording speed control method and a recording speed control device for a recording and reproducing apparatus. As a result, when in high speed recording, the recording speed could be preciously control to ensure correct data recording.

Finally, those skilled in the art should appreciate that they can readily use the disclosed conception and specific embodiment as a basis for designing or modify other structures for carrying out the same purpose of the present invention without departing from the spirit and scope of the invention as defined by the appended claim

1. A recording speed controlling device of a recording and reproducing apparatus, comprising:
a compensator, compensating a first reference signal as a second reference signal;
a low pass filter, coupled to said compensator, low-pass filtering said second reference signal as a third reference signal;
a peak to peak voltage detector, coupled to said low pass filter, detecting a peak-to-peak voltage of said third reference signal; and
a driver, coupled to said compensator and said peak to peak voltage detector, controlling an optical pickup unit to record and read a disk;
wherein when a peak-to-peak voltage of said third reference signal reaches a threshold voltage, said drivers controls said optical pickup unit to reduce recording speed.

2. The device of claim 1, wherein said low pass filter is a second-order low pass filter.

3. The device of claim 1, wherein said first reference signal is a focus error signal and said second reference signal is a focus servo output signal.

4. The device of claim 1, wherein said first reference signal is a tracking error signal and said second reference signal is a tracking servo output signal.

5. The device of claim 1, wherein the recording and reproducing apparatus is selected from: a CD-RW, DVD+RW, DVD−RW.

6. A recording speed controlling device of a recording and reproducing apparatus, comprising:
a first compensator, compensating a tracking error (TE) signal as a tracking servo output (TRO) signal;
a second compensator, compensating a focus error (FE) signal as a focus servo output (FOO) signal;
a first low pass filter, coupled to said first compensator, low-pass filtering said TRO signal as a TRO_LPF signal;
a second low pass filter, coupled to said second compensator, low-pass filtering said FOO signal as a FOO_LPF signal;
a peak to peak voltage detector, coupled to said first low pass filter and said second low pass filter, detecting peak-to-peak voltages of said TRO_LPF signal and said FOO_LPF signal; and
a driver, coupled to said first compensator, said second compensator and said peak to peak voltage detector, controlling an optical pickup unit to record and read a disk;
wherein when one of said peak-to-peak voltages of said TRO_LPF signal and said FOO_LPF signal reaches a threshold voltage, said drivers controls said optical pickup unit to reduce recording speed.

7. The device of claim 6 wherein said low pass filter is a second-order low pass filter.

8. The device of claim 6 wherein the recording and reproducing apparatus is selected from: a CD-RW, DVD+RW, DVD−RW.

9. A recording speed controlling method of a recording and reproducing apparatus, comprising:
compensating a first reference as a second reference signal;
low-pass filtering said second reference signal as a third reference signal; and detecting a peak-to-peak voltage of said third reference signal;
wherein reducing the recording speed when said peak-to-peak voltage reaches a threshold voltage.

10. The method of claim 9, wherein second order low-passing filtering said second reference signal.

11. The method of claim 9, wherein said first reference signal is a focus error signal and said second reference signal is a focus servo output signal.

12. The method of claim 9, wherein said first reference signal is a tracking error signal and said second reference signal is a tracking servo output signal.

13. The method of claim 9, wherein the recording and reproducing apparatus is selected from: a CD-RW, DVD+RW, DVD−RW.

14. A recording speed controlling method of a recording and reproducing apparatus, comprising:
compensating a TE signal as a TRO signal and a FE signal as a FOO signal;
low-pass filtering said TRO signal as a TRO_LPF signal and said FOO signal as a FOO_LPF signal; and
detecting peak-to-peak voltages (Vpp) of said TRO_LPF signal and said FOO_LPF signal;
wherein reducing the recording speed when one of said peak-to-peak voltages reaches a threshold voltage.

15. The method of claim 14, wherein second order low-passing filtering said TRO signal and said FOO signal.

16. The method of claim 14, wherein the recording and reproducing apparatus is selected from: a CD-RW, DVD+RW, DVD−RW.
